(19) United States
(12) Patent Application Publication
(10) Pub. No.: US 2019/0120987 A1
(43) Pub. Date: Apr. 25, 2019

(54) POSITIONING SEISMIC SOURCES IN A TUNED SOURCE ARRAY

(71) Applicant: PGS Geophysical AS, Oslo (NO)

(72) Inventors: Walter Söllner, Oslo (NO); Okwudili Orji, Drammen (NO)

(21) Appl. No.: 16/166,725

(22) Filed: Oct. 22, 2018

Related U.S. Application Data
(60) Provisional application No. 62/728,725, filed on Sep. 7, 2018.
(60) Provisional application No. 62/576,114, filed on Oct. 24, 2017.

(51) Int. Cl. G01V 1/38

(52) U.S. Cl. CPC G01V 1/3817; G01V 2210/127; G01V 1/3861

(57) ABSTRACT

Techniques are disclosed relating to positioning signal sources in a tuned source array for use in seismic surveying. In various embodiments, a survey vessel deploys a plurality of signal sources distributed in a source array. In some embodiments, the plurality of signal sources includes a first signal source positioned at a first depth in a body of water, and a second signal source positioned at a second, shallower depth in the body of water. Various embodiments include controlling the first and second depths such that the first signal source and the second signal source are positioned at substantially the same distance from a target subsurface location in a geological formation. Further, in various embodiments, the first and second signal sources are activated to generate first and second seismic signals.

### CROSS-REFERENCE TO RELATED APPLICATION

This application claims the benefit of U.S. Provisional Application No. 62/576,114, filed on Oct. 24, 2017, and of U.S. Provisional Application No. 62/728,725, filed on Sep. 7, 2018, both of which are hereby incorporated by reference as if entirely set forth herein. This application is related to U.S. application Ser. No. 16/166,644, filed on Oct. 22, 2018, which is hereby incorporated by reference as if entirely set forth herein.

### BACKGROUND

Geophysical surveys are often used for oil and gas exploration in geological formations, which may be located below marine environments. Seismic surveys, for example, are based on the use of acoustic waves. In seismic surveys, a survey vessel may tow one or more signal sources (e.g., an air gun) and a plurality of streamers along which a number of acoustic sensors (e.g., hydrophones and/or geophones) are located. Acoustic waves generated by the source(s) may be transmitted into the earth's crust and then reflected back and captured at the sensors. Data collected during a marine geophysical survey may be analyzed to locate hydrocarbon-bearing geological formations, and thus determine where deposits of oil and natural gas may be located.

In a typical configuration, a conventional seismic source (e.g., an air gun) is set up such that the energy released into the water has a high peak-to-bubble ratio. When activated, the energy released by the source propagates as a seismic wave, outwards, omnidirectionally, from the ideal center of the source. In some such instances, an undesirably high amount of the energy released by the source may propagate through the water, which can negatively affect the surrounding marine life. Further, the amount of energy trapped in the water column may increase when conducting a survey in a marine environment with shallow waters or hard sea floors, where the seismic waves from the signal source reach critical angles quickly, leading to subsurface penetration problems. In various instances, it may be desirable to perform a seismic survey in a manner that reduces the environmental impact of seismic data acquisition while improving the penetration and illumination of points within the subsurface with difficult geology.

### BRIEF DESCRIPTION OF THE DRAWINGS

FIG. 1 is a block diagram illustrating an example geophysical survey system, according to some embodiments.

FIG. 2 is a block diagram illustrating an example tuned signal source array, according to some embodiments.

FIGS. 3A-3B are block diagrams illustrating the propagation of seismic signals generated by both a conventional signal source and a tuned signal source array, according to some embodiments.

FIG. 4A is a diagram illustrating an example environment in which a geophysical survey may be conducted, according to some embodiments.

FIGS. 4B-4E depict graphs comparing the seismic signals measured at various points within a marine environment, according to some embodiments.

FIGS. 5A and 5B depict graphs of example seismic signals generated by two different signal sources of a tuned signal source array, according to some embodiments.

FIG. 5C depicts a graph of an example combined signal based on the seismic signals shown in FIGS. 5A-5B, according to some embodiments.

FIG. 6 is a block diagram illustrating an example tuned signal source array, according to some embodiments.

FIG. 7 is a flow diagram illustrating an example method for performing a seismic survey using a tuned signal source array, according to some embodiments.

FIGS. 8A-8B show example seismic images, according to some embodiments.

FIG. 9 is a block diagram illustrating an example computing system, according to some embodiments.

This disclosure includes references to “one embodiment,” “a particular embodiment,” “some embodiments,” “various embodiments,” “an embodiment,” etc. The appearances of these phrases do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. “Control equipment configured to activate a signal source” is intended to cover, for example, equipment that has circuitry that performs this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the context clearly dictates otherwise. Furthermore, the words “can” and “may” are used throughout this application in a permissive sense (i.e., having the potential to, being able to), not in a mandatory sense (i.e., must). The term “include,” “comprise,” and derivations thereof, mean “including, but not limited to.” The term “coupled” means directly or indirectly connected.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

### DETAILED DESCRIPTION

### Example Survey System

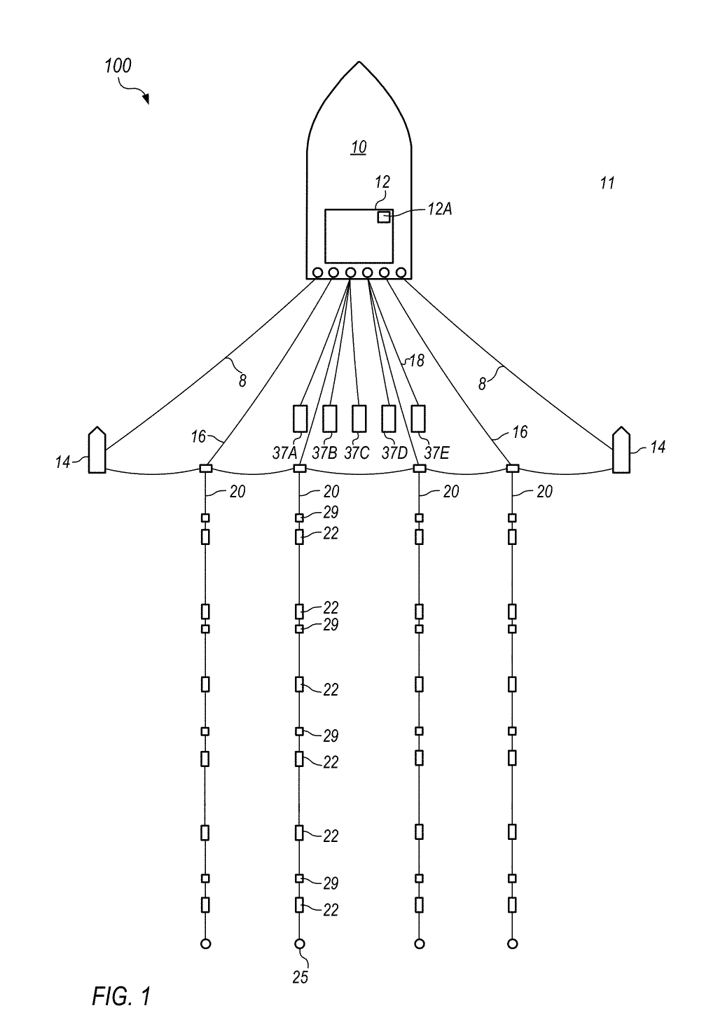

FIG. 1 is a block diagram illustrating a geophysical survey system 100, according to some embodiments. In various embodiments, survey system 100 is configured to acquire geophysical data corresponding to geological structures disposed below body of water 11. In the illustrated embodiment, system 100 includes survey vessel 10, which tows signal sources 37, streamers 20, and paravanes 14. In other embodiments, at least a portion of streamers 20 may be towed by a second survey vessel (not shown), in place of or in addition to survey vessel 10. Similarly, in some embodiments, at least a portion of signal sources 37 may be towed by one or more additional survey vessels (not shown), in place of or in addition to survey vessel 10.

In survey system 100, survey vessel 10 is shown towing five signal sources 37A-37E (referred to collectively as “sources 37” or “signal sources 37”) using source cables 18. Note that, in some embodiments, sources may be towed in various patterns (e.g., square or circular patches) using various cable configurations for multi-dimensional data acquisition. In various embodiments, survey vessel 10 may tow any appropriate number of signal sources, including as few as none (e.g., when sources are towed by another vessel) or as many as six or more. In various embodiments, one or more of signal sources 37 may be vibratory signal sources that may be configured to be driven according to a given function by control equipment 12. For example, in various embodiments, one or more of signal sources 37 may be vibratory signal sources configured to be driven according to a given function or digital code.

In FIG. 1, signal sources 37 are laterally spaced, relative to a centerline of survey vessel 10, to form an array of signal sources 37. As discussed below, various embodiments of the present disclosure utilize a tuned seismic signal source array that focuses the energy emitted by the sources in the array at a desired location (e.g., focal point) in the subsurface of a geological structure. In various instances, such a tuned array of signal sources 37 improves illumination of a subsurface location while reducing the environmental impact of seismic acquisition.

Survey vessel 10 includes equipment, shown generally at 12 and, for convenience, collectively referred to as “control equipment.” Control equipment 12 may include devices such as a data recording unit (not shown separately) for making a record of signals generated by various geophysical sensors 22 in the system 100. Control equipment 12 may also include navigation equipment (not shown separately), which may be configured to control, determine, and record, at selected times, the geodetic positions of: survey vessel 10, each of a plurality of geophysical sensors 22 disposed at locations on streamers 20, and signal sources 37. Geodetic position may be determined using various devices, including global navigation satellite systems such as the global positioning system (GPS), for example. In the illustrated embodiment, survey vessel 10 includes geodetic positioning device 12A. Additional positioning devices may be placed at various locations on streamers 20 in some embodiments. In some embodiments, control equipment 12 is configured to control sources 37, e.g., to control when the sources 37 activate, where the sources 37 are positioned, the manner in which the sources 37 are activated, etc. Note that, although control equipment 12 is shown on survey vessel 10, this embodiment is provided merely as an example and is not intended to limit the scope of the present disclosure. In various embodiments, various components of control equipment 12, or the entirety of control equipment 12, may alternatively be located on a separate vessel (not shown) or at a remote location as desired.

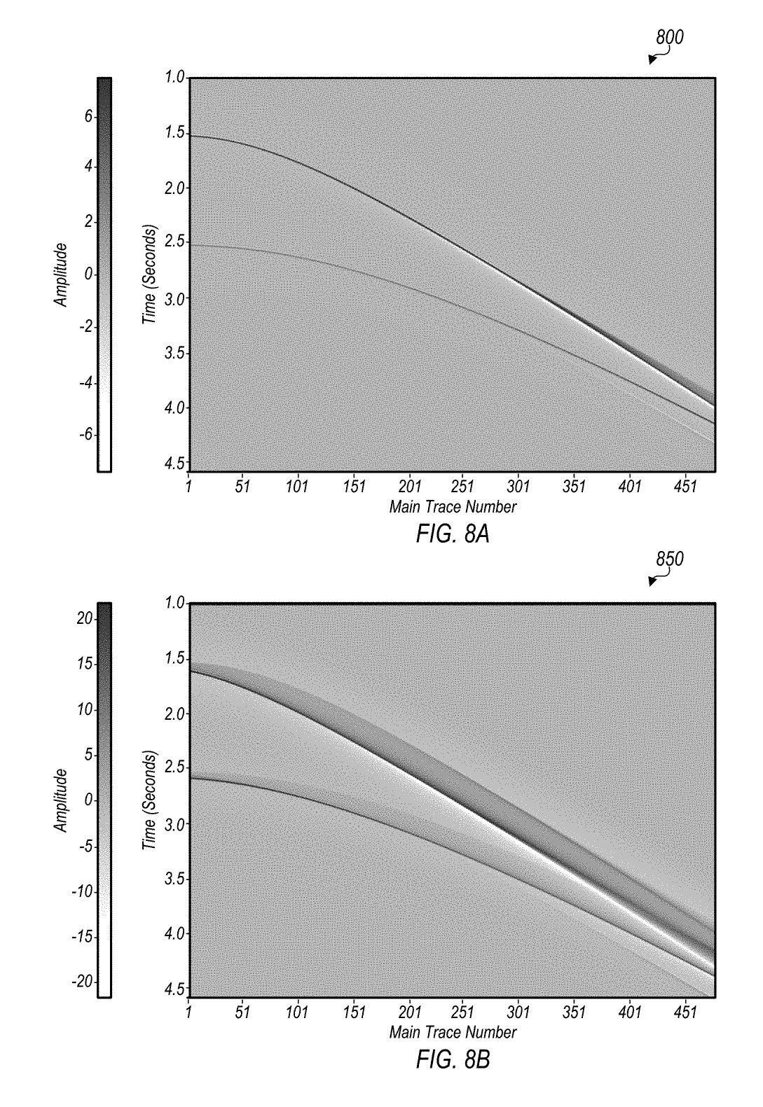

Control equipment 12, in various embodiments, includes a computing system (an example embodiment of which is discussed below with reference to FIG. 8) configured to, inter alia, process sensor outputs from geophysical sensors 22. In other embodiments, a computing system at another location may process geophysical data gathered by geophysical survey system 100 (e.g., on land after a survey has been conducted). A computing system may include or be configured to access a non-transitory, computer-readable storage medium having instructions stored thereon that are executable to perform various operations described herein in order to conduct a survey or process sensor outputs generated during a survey. A computing system may include one or more processors configured to execute the program instructions to cause a system to perform various functionality described herein.

In FIG. 1, survey vessel 10 tows four streamers 20 using lead-in cables 16. In various embodiments, however, survey vessel 10 may tow any appropriate number of streamers, including as few as none (e.g., when streamers are towed by another vessel) or as many as 26 or more. Streamers 20 of FIG. 1 include geophysical sensors 22. Geophysical sensors 22 on streamers 20 may be any of various types of geophysical sensor. Examples include hydrophones and/or geophones in some embodiments. Non-limiting examples of such geophysical sensors may include particle motion responsive seismic sensors such as geophones and accelerometers, pressure responsive seismic sensors such as hydrophones, pressure-time-gradient responsive seismic sensors, electrodes, magnetometers, temperature sensors, or any suitable combination of the foregoing. In various implementations of the disclosure, geophysical sensors 22 may measure, for example, seismic field energy indicative of the response of various structures in the Earth's subsurface formation below the bottom of body of water 11 to energy imparted into the subsurface formation by one or more of signal sources 37. Seismic energy, for example, may originate from signal sources 37 deployed in body of water 11 and towed by survey vessel 10.

In various embodiments, streamers 20 may include any of various appropriate modules in addition to geophysical sensors 22. In geophysical survey systems that include a plurality of laterally spaced-apart streamers, such as system 100, streamers 20 are typically coupled to towing equipment that secures the forward end of each of streamers 20 at a selected lateral position with respect to adjacent streamers and with respect to survey vessel 10. For example, as shown in FIG. 1, the towing equipment may include two paravanes 14 coupled to survey vessel 10 via paravane tow ropes 8. In the illustrated embodiment, paravanes 14 are the outermost components in the streamer spread and may be used to provide lateral streamer separation. In some embodiments, survey vessel 10 may be configured to tow different streamers 20 at different depths and/or different lateral displacements from a centerline of survey vessel 10. In FIG. 1, streamers 20 further include birds 29, which are steering devices configured to maintain streamers 20 in a desired position (e.g., at a specified depth and/or lateral displacement). Similarly, steering devices may be used to facilitate positioning of sources 37. In some embodiments, survey vessel 10 may be configured to tow streamers 20 using various geometries such as different feather angles, depth profiles, etc. In some embodiments, streamers 20 may include multiple geodetic positioning devices (not shown). In some embodiments, streamers 20 include tail buoys 25.

As noted above, a conventional seismic source, such as an air gun, may be configured such that the energy released into the water has a high peak-to-bubble ratio. When activated, the energy released by such a conventional source propagates as a seismic wave outwards, omnidirectionally from the ideal center of the source. While some of that energy is reflected off of the subsurface and collected by one or more sensors, a high amount of the energy released by the source may propagate through the water column, which may be hazardous to surrounding marine life. Further, the amount of energy trapped in the water column may increase when conducting a survey in a marine environment with shallow waters or hard sea floors, where the seismic waves from the signal source reach critical angles quickly, leading to subsurface penetration problems. Thus, in various instances, conventional seismic sources may have a negative impact on surrounding marine life while suffering from poor illumination of the subsurface, thus presenting a technical problem in the field of seismic surveying.

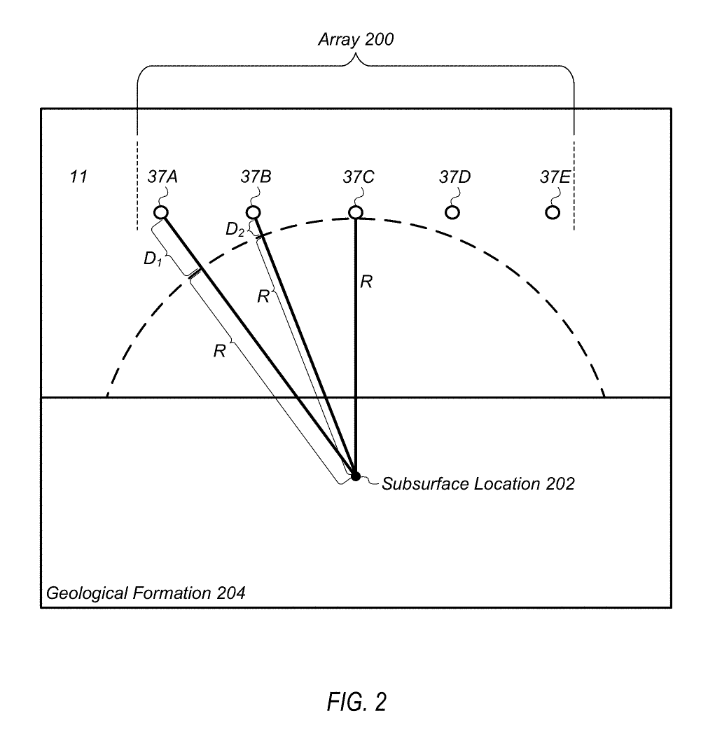

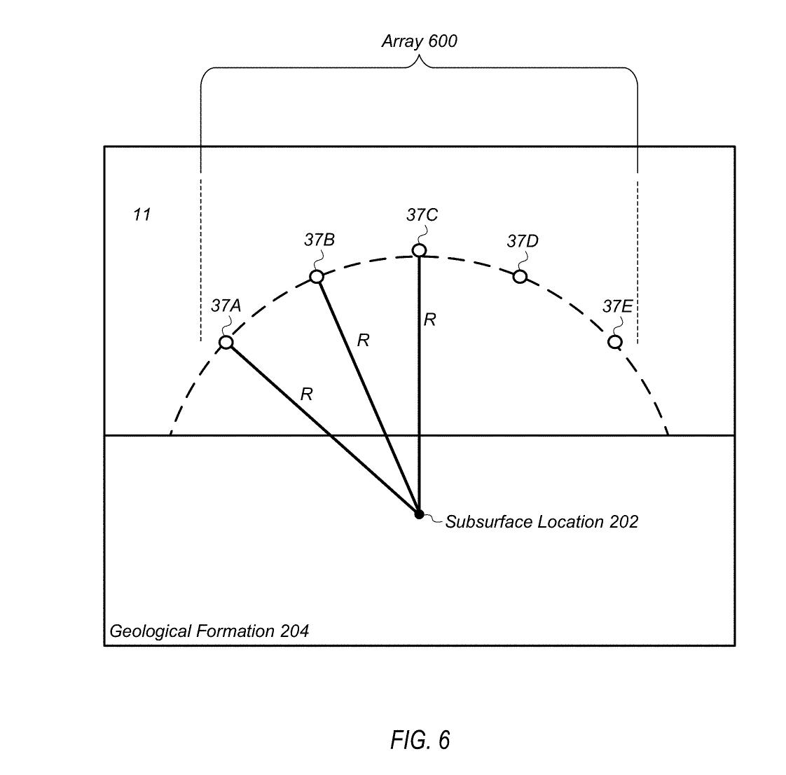

In various embodiments, however, the systems and methods disclosed herein allow for improved illumination of a subsurface location while reducing the environmental impact of seismic data acquisition. As explained in more detail below, various embodiments utilize a tuned seismic signal source array that focuses the energy emitted by the sources in the array at a desired subsurface location of a geological structure. For example, as discussed with reference to FIG. 2 below, various embodiments include activating signal sources that are farther away from a desired focal point in the subsurface before activating signal sources that are closer to the desired focal point. By selecting and applying appropriate time delays for the different sources 37 within the array, various embodiments of the disclosed systems and methods cause the wavefronts for the seismic signals to converge at the subsurface location at substantially the same time. In other embodiments, as discussed with reference to FIG. 6 below, various embodiments include towing signal sources 37 in a configuration in which multiple signal sources 37 in the array are nominally at the same distance from a subsurface location of interest. In such embodiments, each of the sources 37 that are the same distance from the location of interest may be activated at the same (or substantially the same) time to cause the wavefronts for the seismic signals to converge at the subsurface location at substantially the same time.

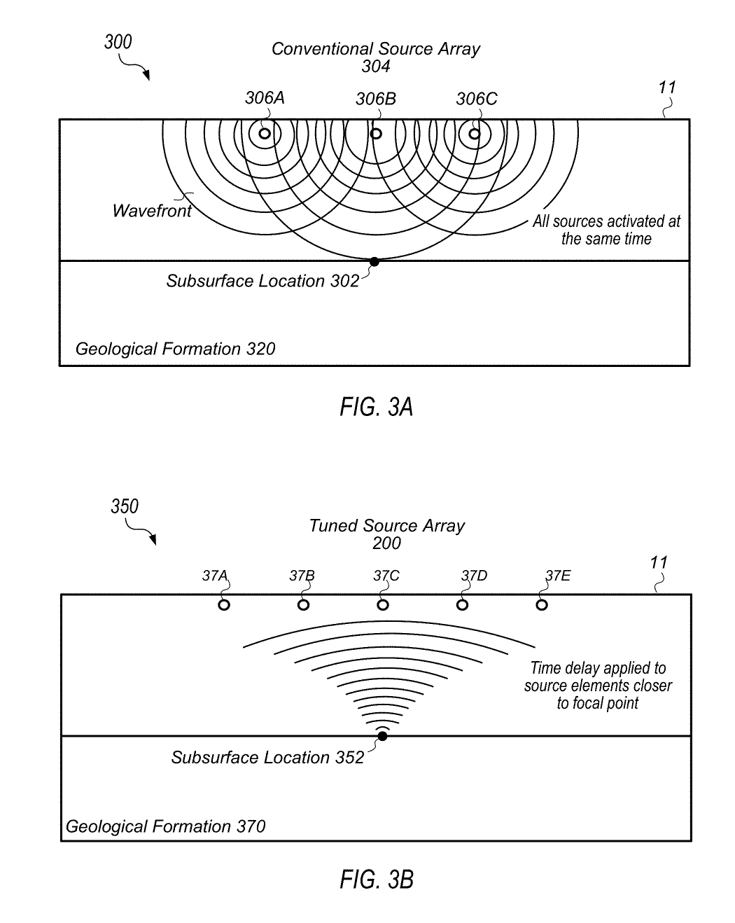

When these seismic signals converge at the subsurface location at the same time, the signals positively reinforce each other. In various instances, the net amplitude of the pressure of the combined seismic signals will be greater than, and thus have a higher energy than, the individual seismic signals. This increase in energy, in turn, may provide for better penetration of the subsurface for the reflected seismic signal while reducing the environmental impact of seismic surveying. Further, in some embodiments of the present disclosure, the amplitude of the signals generated by the array may be “tapered” such that the sources 37 on the outside of the array generate lower amplitude signals than those sources positioned more centrally in the array, as discussed in more detail below with reference to FIG. 3B. In various embodiments, such spatial amplitude tapering may further reduce the environmental impact of seismic surveying while maintaining or improving survey accuracy and precision.

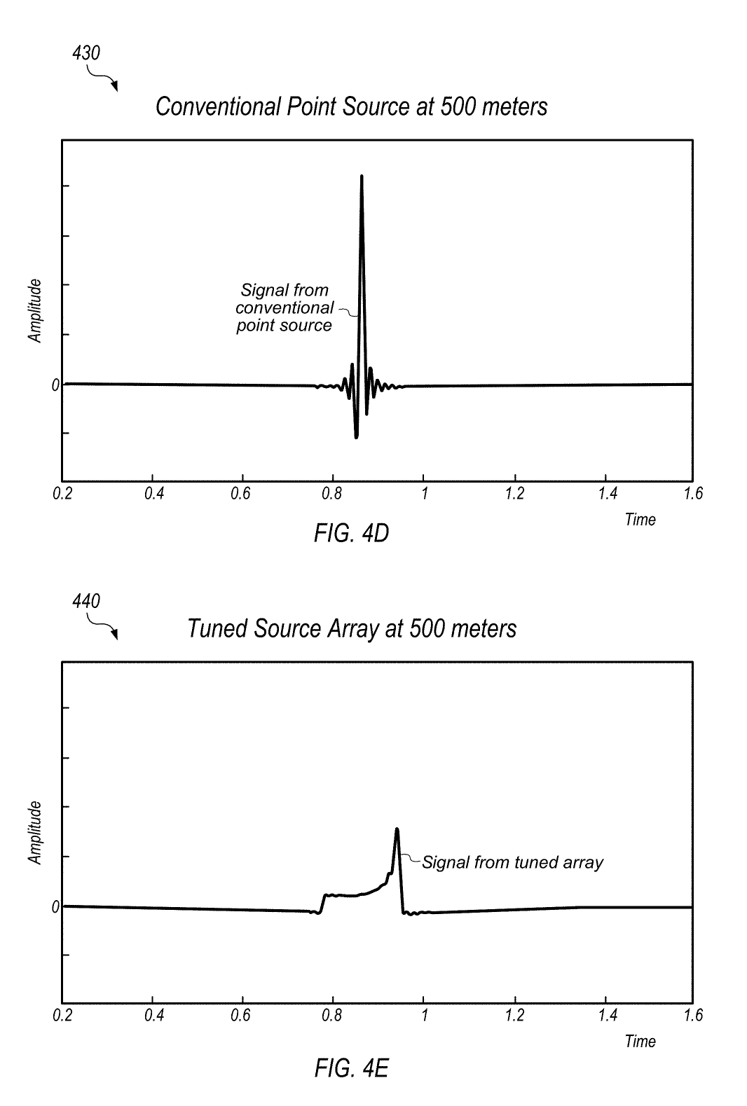

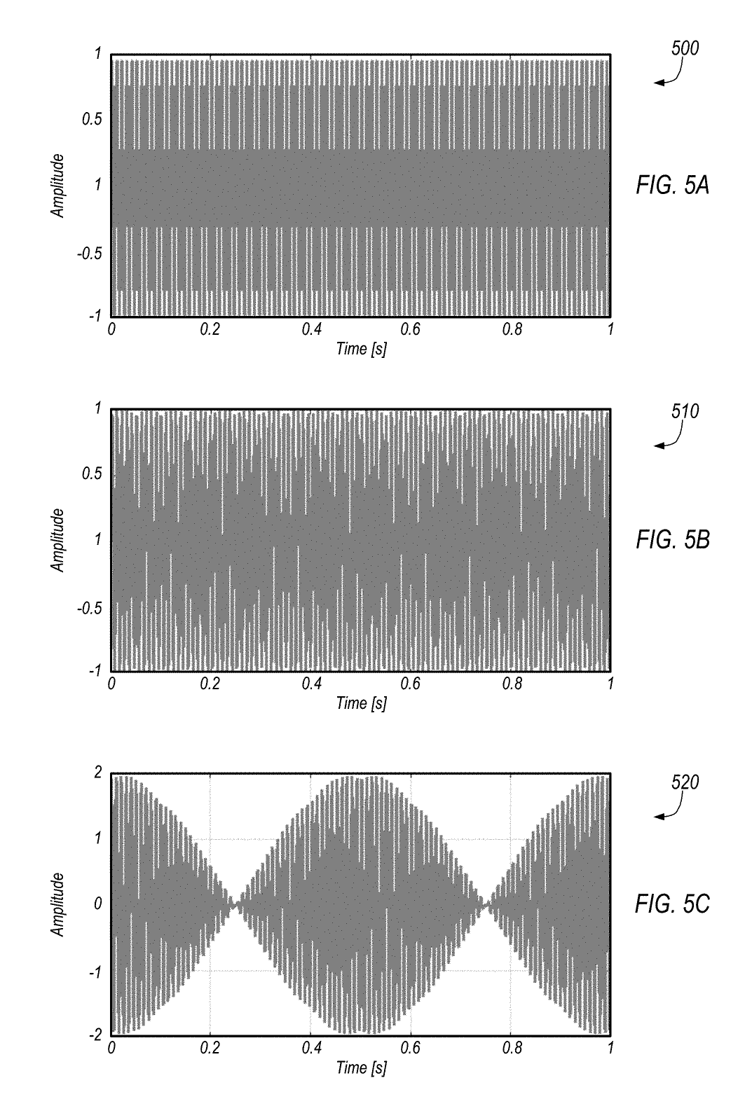

Further, in various embodiments, a tuned seismic source array may be used to generate a combined seismic signal within a lower frequency band than the frequency of the signals generated by individual signal sources 37, without requiring system 100 to utilize low-frequency signal sources. For example, as discussed in more detail below with reference to FIGS. 5A-5C, various embodiments may generate seismic signals, using different sources 37, with a slightly different frequency. For example, a first signal source 37 may generate a seismic signal with a frequency of 100 Hz, while a second signal source 37 may generate a seismic signal with a frequency of 102 Hz. By appropriately delaying the activation of at least one of these two sources 37 such that the wavefronts of their respective seismic signals converge at the focal point at substantially the same time, the amplitude of the combined seismic signal may be modulated by the difference frequency (e.g., 2 Hz in the given example).

Thus, various embodiments of the present disclosure allow for the acquisition of seismic signals that include a low frequency component without actually injecting a low frequency signal into the marine environment. Such embodiments provide various technical improvements to the functioning of system 100. For example, low-frequency signal sources are typically larger and thus more difficult to tow. Additionally, low-frequency signal sources tend to have more impact on the marine environment in which they are operated. Therefore, using the disclosed systems and methods, in various embodiments, allows for the acquisition of seismic data with a low-frequency component in a manner that reduces the cost and difficulty associated with conventional low-frequency signal sources while reducing the environmental impact of the seismic survey.

Accordingly, in at least some embodiments, the disclosed systems and methods provide various improvements to the functioning of survey system 100, improving the seismic surveying process as a whole. For example, in some such embodiments, focusing the energy from the signal sources 37 at a particular focal point in the subsurface may enable better imaging of subsurface structures in areas that are traditionally difficult to image due to poor penetration and illumination (e.g., areas with a hard sea floor or geologically complex structures, such as salt domes). Further, in various embodiments, the disclosed systems and methods may reduce the environmental impact associated with seismic data acquisition. Thus, in at least some embodiments, the disclosed systems and methods provide a technical improvement to geophysical surveying by allowing for improved data acquisition in environments with challenging geological structures while reducing the environmental impact of seismic data acquisition.

Turning now to FIG. 2, a block diagram illustrating an example tuned signal source array 200 is shown, according to some embodiments. More specifically, FIG. 2 depicts a plurality of signal sources 37 positioned to form an array 200. Note that, although five signal sources 37 are shown in array 200 depicted in FIG. 2, any suitable number (e.g., three, four, six, etc.) of signal sources 37 may be included in the array 200 as desired. In various embodiments, the signal sources 37 in tuned source array 200 may be any of various types of signal source. For example, in various embodiment, signal sources 37 are vibratory signal sources. In other embodiments, the signal sources 37 in tuned source array 200 are impulsive-type sources, such as air guns. Similar techniques may be performed using other source types, as desired.

In FIG. 2, array 200 is shown located above a geological formation 204. Further, in FIG. 2, subsurface location 202 is shown within the subsurface of geological formation 204. In various embodiments, subsurface location 202 may correspond to a point of interest (e.g., a focal point) within geological formation 204. Note, however, that although subsurface location 202 is shown at a particular depth in FIG. 2, the location of subsurface location 202 may be adjusted (e.g., during a seismic survey, etc.) to image various points of interest within the geological formation 204. Various disclosed embodiments may collect seismic data corresponding to subsurface location 202 by focusing energy from signal sources 37 at that location. As noted above, this focusing of energy may allow for improved penetration and illumination of a point of interest within geological formation 204, even in the presence of challenging geological conditions.

In various embodiments, the distance between a given signal source 37 in array 200 and the subsurface location 202 may be determined based on the physical configuration of the array 200 and the location (e.g., depth and lateral position relative to the array 200) of subsurface location 202. For example, in some embodiments, the signal sources 37 in array 200 may be towed at known lateral positions relative to one another. Further, in various embodiments, the depth of the subsurface location 202 may also be known. Based on this information, as well as information corresponding to the velocity of the medium through which the seismic signals will be propagating, the time it will take for a seismic signal from a given source 37 in the array 200 to reach the subsurface location 202 may be determined. From these times, one may calculate the delay period(s) necessary to apply to the different signal sources 37 to cause the wavefronts of the seismic signals to arrive at the subsurface location 202 simultaneously or near-simultaneously. As the terms are used herein, “near-simultaneous” arrivals and arrivals at “substantially the same time” include those without meaningful differences in time between them. For example, although it is understood that the tuned wavefronts may not arrive at exactly the same time in real-world conditions (e.g., based on minor errors in the positioning of sources or timing of activations), the sources may be controlled such that the wavefronts arrive within a reasonable threshold time interval of each other, e.g., that does not cause more than a threshold amount of noise in measured signals. Said another way, the time interval between arrivals of “near-simultaneous” wavefronts at the focal point should typically be small relative to the frequency of the source signals, to avoid destructive interference between the source signals. Note that, although the term “focal point” is used throughout this disclosure, embodiments of the present disclosure are not limited to focusing energy solely at a single point. Instead, in various embodiments, the disclosed systems and methods may be used to cause the source wavefield to collapse on any arbitrarily shaped reflector in the subsurface.

For example, in the embodiment depicted in FIG. 2, assume that subsurface location 202 is located at a position in geological formation 204 that is directly beneath the central signal source 37C in array 200. In FIG. 2, the distance between signal source 37C and the subsurface location 202 is denoted as “R.” Since other sources 37 (sources 37A, 37B, 37D, and 37E) in the array 200 are laterally offset relative to signal source 37C, the distance between those other sources 37 and the subsurface location 202 is greater than R. Further assume that each of the signal sources 37 in array 200 are spaced apart evenly, such that the distance from signal source 37B to subsurface location 202 is the same as the distance from signal source 37D to subsurface location 202, and that the distance from signal source 37A to subsurface location 202 is the same as the distance from signal source 37E to subsurface location 202. For example, in the depicted embodiment, the distance between an outermost source 37A and the subsurface location 202 is R plus D₁, where D₁ denotes the difference in distance from source 37A to subsurface location 202 relative to the distance from source 37C to subsurface location 202. Similarly, the distance between signal source 37B and subsurface location 202 is R plus D₂, where D₂ denotes the difference in distance from source 37B to subsurface location 202 relative to the distance from source 37C to subsurface location 202. Note, however, that this embodiment is provided merely as an example and is not intended to limit the scope of the present disclosure. In other embodiments, any suitable spacing of signal sources 37 may be used as desired.

One of ordinary skill in the art with the benefit of this disclosure will note that the time it takes for the wavefront of a seismic signal generated by a source 37 to reach subsurface location 202 depends on multiple factors, including the distance of the particular signal source 37 from the subsurface location 202. Accordingly, in various embodiments, the time delay applied before activating a given signal source 37 is based, at least in part, on the distance from the given source 37 to the subsurface location 202. In the depicted embodiment, signal source 37C is closest to subsurface location 202 and, therefore, the wavefront of the seismic signal generated by signal source 37C will take the least amount of time to reach subsurface location 202 (relative to the other sources 37 in the array 200). Signal sources 37B and 37D are a greater distance away from subsurface location 202 and, accordingly, the wavefronts of seismic signals generated by signal sources 37B and 37D will take a greater amount of time to reach subsurface location 202 (relative to the signal generated by signal source 37C). Similarly, signal sources 37A and 37E are farther still from subsurface location 202 and, therefore, the wavefronts of seismic signals generated by signal sources 37A and 37E will take an even greater amount of time to reach subsurface location 202 (relative to the signals generated by signal sources 37B and 37D). Accordingly, in the embodiment depicted in FIG. 2, it will take longer for signals from sources 37A and 37E to reach subsurface location 202 than it will for signals from sources 37B and 37D, which will take longer than signals from source 37C.

In various disclosed embodiments, the signal sources 37 in array 200 are tuned such that the energy emitted by signal sources 37A-37E is focused at subsurface location 202 within geological formation 204. This may be accomplished by tuning array 200 such that the wavefronts of the signals generated by each signal source 37 in the array 200 converge at the subsurface location 202 at substantially the same time. As used herein, the term “tuned” refers to the modification of one or more characteristics associated with the activation (that is, one or more “activation characteristics”) of a signal source 37 within an array 200. In some embodiments, the array 200 may be tuned by applying a time delay between the activation of one or more of the signal sources 37 within the array. For example, in various embodiments, signal sources 37 that are farther from subsurface location 202 are activated before signal sources 37 that are closer to subsurface location 202. Stated conversely, sources 37 that are closer to subsurface location 202 may be delayed relative to sources that are farther away from subsurface location 202. Further, the delay period between activations may vary based on a particular source 37's distance from subsurface location 202, with larger delay periods being applied to the activation of sources that are closer to subsurface location 202. Therefore, in various embodiments, the largest relative time delay is applied to the source 37 closest to the subsurface location 202 (e.g., source 37C) with the time delay decreasing for more distant sources 37 (e.g., sources 37B and 37D), with the most distant sources 37 (e.g., sources 37A and 37E) having no relative time delay before activation. For example, in the embodiment of FIG. 2, signal sources 37A and 37E may be activated first, followed by signal sources 37B and 37D, and finally followed by signal source 37C. The delay periods between activating different sources 37 in the array 200 may be calculated and selected such that the wavefronts of the respective seismic signals converge at the subsurface location 202 at substantially the same time.

In other embodiments, however, the array 200 may be tuned by applying a phase delay to the seismic signal generated by one or more of the signal sources 37 in the array 200. Stated differently, in some embodiments, one or more of the signal sources 37 may generate a time-delayed version of the seismic signal generated by one or more other signal sources 37. In some embodiments, sources 37 that are closer to the subsurface location 202 may generate a time-delayed version of the seismic signal generated by sources 37 that are farther away from the subsurface location 202. For example, in some embodiments, source 37A may generate a particular seismic signal (e.g., based on a function or digital code) at a first time, and source 37C may generate a time-delayed version of the same particular seismic signal, such that there is a phase difference between the seismic signals generated by sources 37A and 37C. In various embodiments, the extent of this phase difference corresponds to a difference in the sources 37A and 37C respective distance from the subsurface location. Note that, in various such embodiments, the signal sources 37A and 37C may be activated at the same or substantially the same time, with source 37C generating a time-delayed version of the seismic signal generated by source 37A. In other embodiments, however, sources 37A and 37C may be generated at different times, with the extent of the phase difference between the seismic signals generated by the two sources adjusted such that the respective resulting waveforms collapse at the subsurface location substantially in-phase with each other.

In still other embodiments (such as those discussed with reference to FIG. 6), an array 200 may be tuned by adjusting the relative position of one or more signal sources 37 within the array, thereby adjusting the distance from that source 37 to a subsurface location of interest. Note that, in various embodiments, an array 200 may be tuned to focus the energy emitted by one or more of the signal sources 37 at subsurface location 202 using any suitable combination of time-delay between activations of one or more signal sources 37, phase-delay between the seismic signal generated by one or more signal sources 37, or adjustments of the relative position of one or more sources 37.

As used herein, “activation” of a signal source is intended to be construed according to its well-understood meaning, which includes causing the signal source to begin emitting a particular seismic signal. Note that, in some embodiments, the signal source may have also been emitting other signals prior to beginning to emit the particular seismic signal. For example, in embodiments in which a source 37 is a vibratory signal source, “activation” of the vibratory source is intended to include causing at least a portion of the source to begin vibratory movement in a body of water. Typically, vibratory sources are driven using codes or functions, such as linear sweeps, random sweeps, Gold codes, m-sequences, other modulation sequences, etc. Note that, even while activated, a vibratory signal source may happen to be still momentarily, e.g., at a peak or valley of a wave-style modulation when changing directions, but it is still considered activated during that moment. In embodiments in which a source 37 is an impulsive-type signal source (e.g., an airgun), “activation” of the impulsive-type source is intended to include causing the source to emit a seismic impulse (e.g., causing compressed air within an airgun to be discharged). Note that incidental movement of a signal source, e.g., due to environmental conditions such as ocean currents, is not considered an activation of the source.

As noted above, the time it takes for a signal from a particular source 37 to reach subsurface location 202 is based on the distance between the two points. Thus, the difference in distance from the subsurface location 202 may be used to determine the delay period applied to the different sources 37 in the array 200. For example, in the embodiment of FIG. 2, the time delay applied to source 37C may be calculated (e.g., using the propagation velocity of the water) based on D₁, the difference in distance from source 37A to subsurface location 202. Additionally, the time delay applied to sources 37B and 37D may be calculated based on a difference between D₁ and D₂—the difference in distance to subsurface location 202 from source 37A relative to source 37B. Stated differently, the delay period between activating source 37A and source 37B, in various embodiments, corresponds to a difference in their respective distances from subsurface location 202. Therefore, when planning a seismic survey, these distances, along with the depth of the desired subsurface location 202, can be used to calculate the time delays to apply to the different sources 37 in the array 200.

In addition to being dependent on distance, however, the time required for a wavefront of a seismic signal from a source 37 to reach subsurface location 202 may also depend on other survey variables such as the properties of the medium through which the signal is propagating. Thus, while the time delays may be estimated prior to conducting the survey, the actual time required for the wavefronts to reach the subsurface location 202 may vary slightly from the estimated time. Therefore, in various embodiments, it may be desirable to adjust the delay times, during the course of a seismic survey, to cause the wavefronts to better converge at the subsurface location 202 at substantially the same time. For example, in one embodiment, after a first activation of the sources 37 in the array 200, sensors 22 disposed in various streamers 20 may collect reflected signals. From these reflections, the response times of the individual sources 37 in the array 200 may be determined. For example, in one embodiment, the signal generated by source 37D may take longer to reach the subsurface location 202 than the signal generated by source 37B, resulting in a combined wavefield at the subsurface location 202 that is not optimally focused. Using this response time information, the delay period associated with one or more sources 37 (that is, the relative time at which the individual sources 37 of the array 200 are activated) may be dynamically adjusted to cause the wavefronts of the respective signals to converge at the subsurface location 202 closer in time. This calibration process may be repeated as necessary until response times for each of the sources 37 in the array 200 fall within some predetermined threshold. Further, this calibration process may be repeated as necessary or throughout the course of a survey to allow for better focusing of energy at a desired subsurface location.

Causing the wavefronts of the signals generated by sources 37 in array 200 to converge at the subsurface location 202 at substantially the same time, in at least some embodiments, allows for improved penetration and illumination of the subsurface location 202, particularly in situations in which geological formation 204 includes challenging formations (e.g., a hard sea floor, salt domes, etc.). For example, when the wavefronts of the signals converge at subsurface location 202, the resulting combined wave is the superposition of the wavefields from the individual sources 37 in the array 200. In various instances, the energy of the reflected signal is based on the energy of the signals that strike the reflection point (e.g., subsurface location 202). Accordingly, by causing the wavefronts from the multiple sources to converge at the subsurface location 202 at substantially the same time, the energy of the reflected signal is increased. In various embodiments, the increase in energy is given by the reversed geometric spreading of a wavefield that is generated by a virtual point source at the focal point and measured at the physical source positions. This increased energy, in turn, increases the ability of the reflected signal to penetrate the subsurface structures and be detected by sensors 22 disposed within the streamers 20. On the other hand, the forward propagating wavefield from the focal point may behave like a wavefield from a new source closer to the target and leads, in at least some embodiments, to improved seismic resolution due to increased spectral bandwidth.

Referring now to FIGS. 3A-3B, block diagrams 300 and 350 are shown illustrating the propagation of seismic signals generated by an example conventional signal source array 304 (depicted in FIG. 3A) as compared to the propagation of seismic signals generated by an example tuned source array 200 (depicted in FIG. 3B), according to some embodiments.

In FIG. 3A, a conventional signal source array 304, which includes three signal sources 306A-306C, is shown. In the depicted embodiment, conventional signal source array 304 is an un-tuned array, meaning that each of the signal sources 306A-306C in array 304 is activated at substantially the same time.

As shown in FIG. 3A, when each of the signal sources 306 is activated at the same (or substantially the same) time, the wavefronts of the respective seismic signals do not arrive at the subsurface location 302 at substantially the same time. For example, because source 306B is positioned closest to subsurface location 302, the wavefront of the seismic signal generated by source 306B reaches the subsurface location 302 first. Similarly, because signal sources 306A and 306C are positioned farther from subsurface location 302, the wavefront of the seismic signals generated by sources 306A and 306C reach the subsurface location 302 at a later time. As noted above, causing the wavefronts of the seismic signals generated by a source array to collapse at a focal point at substantially the same time can increase the amplitude of the resulting reflected signal, improving penetration and illumination of the subsurface at the focal point. Thus, conventional source array 304 depicted in FIG. 3A fails provide a technical solution to the technical problem in geophysical surveying caused by challenging geological formations.

In FIG. 3B, the propagation of seismic signals generated by sources 37 of a tuned signal source array 200 is shown, according to some embodiments. In some embodiments, tuned source array 200 corresponds to array 200 shown in FIG. 2. Note that, in various embodiments, tuned signal source array 200 is larger in size than conventional source array 304. For example, in various embodiments, the size of the tuned signal source array 200 is sufficiently large to provide proper focusing of energy at a desired subsurface location 352. Further note that, in some embodiments, the size of tuned signal source array 200 may adjusted based on the depth of subsurface location 352.

As noted above, in various embodiments, signal sources that are farther from a focal point are activated before sources that are closer to the focal point such that the wavefield created by the tuned array will converge at the focal point at substantially the same time. For example, in FIG. 3B, signal sources 37A and 37E may be activated first, followed by signal sources 37B and 37D, and finally signal source 37C. Further, in some embodiments, the amount of the time delay between activating different sources may correspond to the relative distances of those sources to a subsurface location 352, as described above. By activating the signal sources 37 in an order that is based on their respective distance from a focal point, utilizing tuned source array 200 allows for the wavefronts of the seismic signals created by the sources 37 to converge at the subsurface location 352 at substantially the same time. Note that, in FIG. 3, the propagation of the wavefronts for the tuned array have been simplified to more clearly demonstrate that, by delaying the activation of sources 37 closer to a focal point (e.g., signal source 37C) relative to the activation of sources 37 more distant from the focal point (e.g., signal source 37A), the wavefronts of the signals can be caused to converge at the focal point at substantially the same time.

Note that, in various embodiments, tuned signal source array 200 may include monopole-type source elements, dipole-type source elements, or both. For example, in various embodiments, tuned signal source array 200 includes both monopole-type source elements and dipole-type source elements, either collocated within array 200 or positioned adjacently or in close proximity to one another within the array 200.

As will be appreciated by one of skill in the art with the benefit of this disclosure, a monopole-type source element may generate (in an ideal case) omnidirectional wavefields with equal amplitude and phase for any fixed distance from the center of the source. In some embodiments, a monopole-type source element may be implemented as a bender-type marine vibrator that is configured to generate seismic signals by performing synchronous movement of its bender plates in opposite directions. For some embodiments in which a bender-type marine vibrator has a small distance between the bender plates compared to the size of the surface of the plates, the output pressure from one source element may be calculated from the acceleration of the plate motion based on the following:

pᵢ^{m}(x_{R},t)=ρ∫_{S}_{₊}g(x,x_{R},t)*[Aₙ(x,t)]dS (1)

where ρ is the water density, g(x, x_{R}, t) is the Green's function that propagates the wavefield from every position x on the plate surface S₊ to the observation position x_{R}, and [Aₙ] is the difference of the normal acceleration across the plates. Example embodiments of monopole-type source elements are described in more detail in U.S. patent application Ser. No. 15/619,719 titled “Marine Vibrator Source Acceleration and Pressure,” filed on Jun. 12, 2017, which is hereby incorporated by reference as if entirely set forth herein.

Further, as will be appreciated by one of skill in the art with the benefit of this disclosure, a dipole-type source element may generate (in an ideal case) up-going and down-going waves with opposite polarity. Further, in some embodiments, the amplitudes of the seismic signals generated by a dipole-type source element may follow a cosine function for any fixed distance from the center of the source with zero output in the direction perpendicular to the direction of plate movement. In some embodiments, a dipole-type source element may be implemented as a bender-type marine vibrator that is configured to generate seismic signals by performing synchronous movement of its bender plates in the same direction. In some embodiments in which bender-type marine vibrators are used, the output pressure of a dipole-type vibrator may be calculated in the far-field range based on the following:

$${p}_{i}^{d} ( {x}_{R} , t ) = - ρ c {\int }_{{S}_{+}} \frac{\partial }{\partial n} g ( x , {x}_{R} , t ) * [ {V}_{n} ( x , t ) ] dS \qquad ( 2 )$$

where the bracket [ ] in (2) denotes the difference of values, in this case the difference of the normal velocity across the plates in the wave propagation direction and the free space Green's function is given by:

$$g ( x , {x}_{R} , t ) = \frac{1}{4 π} \frac{δ ( t - \frac{\vert {x}_{R} - x \vert}{c} )}{\vert {x}_{R} - x \vert} \qquad ( 3 )$$

with c being the propagation velocity in water and

$$\frac{\partial }{\partial n}$$

the normal derivative. Example embodiments of dipole-type source elements are described in more detail in U.S. patent application Ser. No. 15/816,801 titled “Dipole-Type Source for Generating Low Frequency Pressure Wave Fields,” filed on Nov. 17, 2017, which is hereby incorporated by reference as if entirely set forth herein.

In some embodiments, tuned signal source array 200 includes an array of collocated monopole- and dipole-type source elements. In some such embodiments, the output pressure for the entire surface of the array 200 may be provided by:

Σᵢpᵢ^{m}(x_{R},t)+pᵢ^{d}(x_{R},t) (4)

where pᵢ^{m} is the output pressure of a monopole-type vibrator source element, pᵢ^{d} is the output pressure of a dipole-type vibrator source element, and the output pressure wavefield for densely placed elements from the integral of the entire surface, may be provided as follows:

$$p ( {x}_{R} , t ) = \{ \begin{matrix}ρ {\int }_{S} ( g ( x , {x}_{R} , t ) * [ {A}_{n} ( x , t ) ] - c \frac{\partial }{\partial n} g ( x , {x}_{R} , t ) * [ {V}_{n} ( x , t ) ] ) dS \\ for {x}_{R} below x \\ 0 \\ for {x}_{R} above x\end{matrix} \qquad ( 5 )$$

Note that the surface of integration S in (5) includes all the vibrator plate surfaces oriented in the direction normal to the source wavefront. Further, the output pressure wavefield from (5) is predominantly down-going at the source side based on the constructive superposition of monopole-type and dipole-type source elements in the normal downward direction, while the corresponding up-going component is cancelled due to the opposite signs of the wavefield above the source elements in array 200, according to at least some embodiments.

In various embodiments, using a tuned signal source array 200 that includes both monopole-type and dipole-type source elements may provide various improvements to the functioning of the survey system 100. For example, in some embodiments, a monopole-type source element may be used to create an omnidirectional wavefield in which, for a given distance from the monopole-type source in any direction (in a homogeneous medium), the measured wavefield would have the same amplitude and phase. Further, in some embodiments, a dipole-type source element may be used to create a wavefield that is not omnidirectional such that, for a given distance above the dipole-type source element and below the dipole-type source element, the measured wavefield would have an opposite polarity. Accordingly, in various embodiments, utilizing monopole- and dipole-type signal sources in a tuned signal source array 200 may cancel (at least some portion of) the up-going wavefield from the source array, thereby suppressing or removing the source ghost during data acquisition. Stated differently, the up-going wave components generated by monopole-type and dipole-type source elements (that are, for example, collocated or adjacently positioned within a source array) may destructively interfere such that a source ghost received at one or more of the seismic sensors may be reduced. Thus, various embodiments of the present disclosure provide an efficient technique for source-side de-ghosting, where the source ghosts are cancelled at the source during the data acquisition, thereby improving seismic resolution. Further, in at least some embodiments, the removal of the up-going wavefield may reduce the environmental impact of seismic data acquisition by eliminating unused energy at the source array.

As noted above, various embodiments of the present disclosure reduce the environmental impact of seismic data acquisition. For example, by tuning the array 200 to focus seismic energy at a focal point, various embodiments of the disclosed system allow for increased penetration and illumination without introducing an excessively high amount of energy from any one source. In some embodiments, the present disclosure may further reduce the environmental impact of seismic surveying on the surrounding marine environment by tapering the amplitude of the seismic signals generated by sources that are farther from the focal point. For example, array 200, in at least some embodiments, may be tuned such that the amplitudes of the seismic signals generated by the sources 37 are different at different spatial locations within the array 200. Stated differently, the sources 37 within the array may be activated with different amplitude levels at different spatial locations. In various embodiments, such spatial amplitude tapering helps to mitigate the effects of side energy leakage that can occur when all sources 37 in the array 200 generate signals with the same (or substantially the same) amplitude.

For example, in some embodiments, the amplitude of the seismic signals generated by the sources 37 in the outer positions of the array 200 (e.g., sources 37A and 37E) may be less than the amplitude of the seismic signals generated by sources 37 in a more central position in the array 200 (e.g., source 37C). In some embodiments, the amplitude may be progressively decreased for each source 37 farther away from the subsurface location 352. For example, in such an embodiment, source 37C may generate seismic signals with the highest amplitude, sources 37B and 37D may generate seismic signals with a lower amplitude, and sources 37A and 37E may generate seismic signals with a lower amplitude still. Note, however, that this embodiment of spatial amplitude tapering is provided merely as an example and is not intended to limit the scope of the present disclosure. In other embodiments, for example, array 200 may be tuned such that only the amplitude of the signals generated by the outermost sources 37 (e.g., sources 37A and 37E) are decreased. In still other embodiments, any suitable approach for tapering the outer sources 37 may be implemented, such as cosine tapers, Hanning tapers, Hamming tapers, etc.

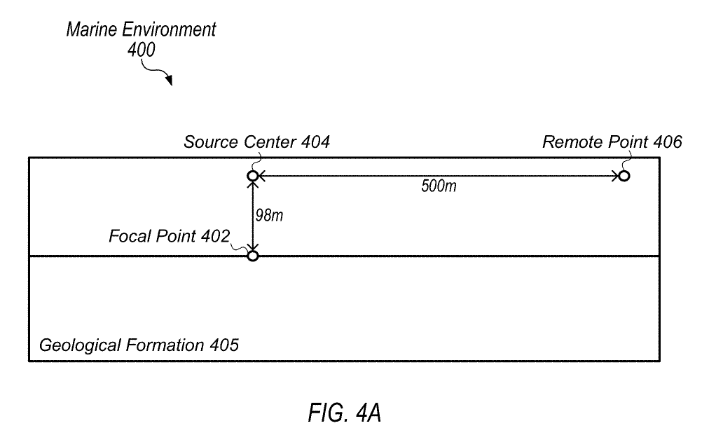

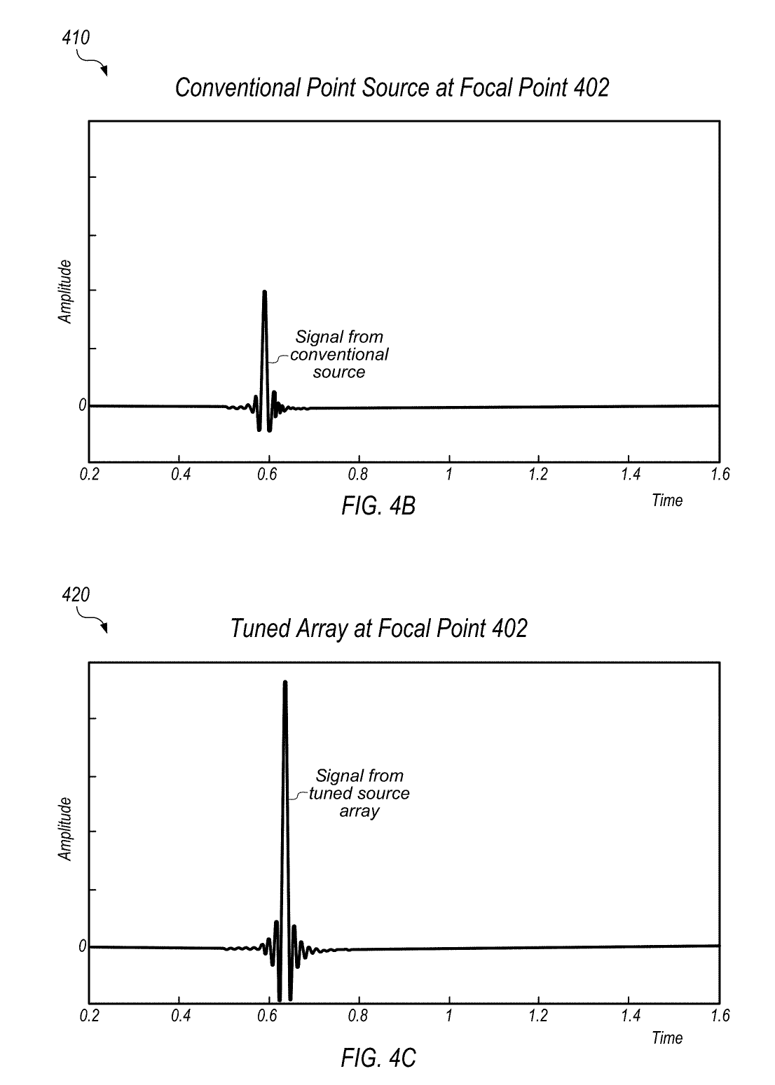

As noted above, various embodiments of the present disclosure may allow a geophysical survey to be performed in a manner that improves penetration and illumination of challenging geological structures while reducing the environmental impact caused by seismic surveys. FIGS. 4A-4E further demonstrate one embodiment of these improvements in geophysical surveying. More specifically, FIG. 4A depicts an example marine environment in which seismic signals may be generated and collected, and FIGS. 4B-4E depict graphs illustrating the difference in amplitude of seismic signals generated by a conventional signal source (e.g., an impulsive type signal source, such as an air gun) as compared to a tuned signal source array, according to one embodiment.

FIG. 4A is a diagram illustrating an example marine environment 400 in which a geophysical survey may be conducted, according to some embodiments. Three points in marine environment 400 are emphasized: focal point 402, source center 404, and remote point 406. Source center 404 denotes a point at which a signal source or source array is centered, in the depicted embodiment. For example, in generating the seismic signal depicted in graphs 410 and 430 of FIGS. 4B and 4D, respectively, a conventional impulsive-type signal source may be positioned at source center 404. Alternatively, in generating the seismic signal depicted in graphs 420 and 440 of FIGS. 4C and 4E, respectively, a tuned source array (such as source array 200) may be centered at source center 404. Focal point 402 indicates a point on geological formation 405. In the depicted embodiment, focal point 402 is located 98 meters directly below source center 404. Measurements corresponding to focal point 402 are depicted in FIGS. 4B and 4C. FIG. 4A further emphasizes remote point 406, which is located 500 meters from source center 404. In the depicted embodiment, remote point 406 is positioned at the same depth within body of water 11 as source center 404. Measurements corresponding to remote point 406 are depicted in FIGS. 4D and 4E.

Turning now to FIGS. 4B and 4C, graphs 410 and 420 illustrating seismic signals received at focal point 402 are respectively shown. More specifically, FIG. 4B shows graph 410, which depicts a seismic signal received at focal point 402 that was generated by a conventional signal source located at source center 404. FIG. 4C shows graph 420, which depicts a seismic signal received at focal point 402 that was generated by a tuned signal source array 200, as disclosed herein, centered at source center 404. As depicted in FIGS. 4B-4C, the peak amplitude of the seismic signal depicted in graph 420 (generated by a tuned signal source array 200) is over twice the peak amplitude of the seismic signal depicted in graph 410 (generated using a conventional signal source). As discussed herein, this increased amplitude, in various embodiments, allows for improved illumination of focal point 402.

Additionally, in various embodiments, performing a seismic survey using a tuned source array, as disclosed herein, reduces the environmental impact on surrounding marine life. For example, with reference to FIGS. 4D and 4E, graphs 430 and 440 illustrating seismic signals received at remote point 406 are respectively shown. More specifically, FIG. 4D shows graph 430, which depicts a seismic signal received at remote point 406 that was generated by a conventional, impulsive-type signal source (e.g., an airgun) located at source center 404. As noted above, remote point 406 is located 500 meters away from, and at the same depth within body of water 11 as, source center 404. In FIG. 4E, graph 440 depicts a seismic signal received at remote point 406 that was generated by a tuned signal source array 200 centered at source center 404. As shown in FIGS. 4D-4E, the seismic signal received at remote point 406 due to the tuned source array 200 has a peak amplitude that is approximately one-third that of the peak amplitude of the seismic signal received at remote point 406 due to the conventional signal source. Note that, in various embodiments, conventional source elements and monopole-only type source elements may generate source ghosts, as will be appreciated by one of skill in the art with the benefit of this disclosure. For clarity, various aspects of the block diagrams and data modeling provided in FIGS. 3-4 have been shown without such a source ghost.

Thus, as demonstrated by FIGS. 4B-4E, the disclosed systems and methods, in various embodiments, provide for improved illumination of a desired focal point while reducing the environmental impact to surrounding marine life.

As noted above, in various embodiments, tuned seismic source arrays, as disclosed herein, may be used to generate a combined seismic signal within a lower frequency band than the frequency of the signals generated by the individual sources 37 in the array. That is, in at least some embodiments, the disclosed systems and methods may be used to collect seismic data in a low-frequency band without requiring the use of low-frequency sources, which are typically larger and more difficult to tow than higher-frequency sources. Referring now to FIG. 5A-5C, an example embodiment in which a seismic signal with a low-frequency component is generated using a disclosed tuned source array is depicted.

In FIG. 5A, graph 500 depicts an example seismic signal generated by a first signal source 37 in a tuned array. In the depicted embodiment, the seismic signal shown in graph 500 has a frequency of 100 Hz. In FIG. 5B, graph 510 depicts an example seismic signal generated by a second signal source 37 in the tuned array. In the depicted embodiment, the seismic signal shown in graph 510 has a frequency of 102 Hz. Thus, in this described embodiment, the tuned array utilizes two signal sources 37 that generate seismic signals at different frequencies. By appropriately delaying the activation of these two sources such that the signals shown in graphs 500 and 510 converge at a focal point at substantially the same time, the two seismic signals will interfere in a desired predetermined manner, with the resulting, combined signal being determined by the superposition of the two individual signals.

For example, in FIG. 5C, graph 520 depicts an example seismic signal created by the interference of the seismic signals shown in graphs 500 and 510. In this depicted embodiment, the combined seismic signal includes both a high-frequency and low-frequency component. That is, as shown in FIG. 5C, the envelope of the combined seismic signal is modulated by the difference in frequency of the two individual seismic signals (2 Hz, in the present example). Thus, various embodiments of the present disclosure allow for the acquisition of seismic signals that include a lower-frequency component without actually injecting low-frequency seismic signals into the marine environment, reducing the cost and difficulty associated with conventional low-frequency signal sources.

As noted above, the time it takes for the wavefront of a seismic signal generated by a source 37 to reach a subsurface location depends on multiple factors, including the distance of the particular signal source 37 from the subsurface location. In some embodiments, such as those discussed with reference to FIG. 2, the sources 37 in array 200 are positioned at the same (or substantially the same) depth within the water such that the distance from a given source 37 to a subsurface location 202 varies depending on the given source 37's location within the array 200. Further, as discussed herein, it is desirable to focus the energy emitted by sources 37 in an array 200 at a desired subsurface location by causing the wavefronts from the seismic signals to converge at the subsurface location at substantially the same time. In the embodiments described with reference to FIG. 2, this focusing of energy is achieved by selecting and applying appropriate time delays for the different sources 37 in the array based on their distance from the subsurface location 202, thereby causing the wavefronts to converge at the subsurface location at substantially the same time.

In other embodiments, however, the disclosed systems and methods may cause the wavefronts of the seismic signals generated by an array to converge at a desired subsurface location by positioning one or more of the signal sources 37 within the array such that the sources are substantially the same distance from the target subsurface location. For example, with reference to FIG. 6, an array 600 is shown located above a geological formation 204 that includes subsurface location 202. In FIG. 6, array 600 includes signal sources 37A-37E distributed in both lateral and vertical positions relative to one another. More specifically, each of signal sources 37A-37E is positioned an equal distance R from the subsurface location 202. (Note that, although omitted from FIG. 6 for clarity, any suitable combination of towing equipment may be used to adjust and maintain the lateral and vertical positions of signal sources 37 in array 600.) Note that, although array 600 is shown in a two-dimensional view in FIG. 6, in some embodiments, array 600 may further include signal sources 37 distributed in both an in-line and cross-line direction at substantially the same distance from the target subsurface location 202.

In various embodiments, each of the signal sources 37 of array 600 may be activated at the same (or substantially the same) time, causing the wavefronts of the resulting seismic signals (with a well-defined wavefront curvature) to converge at the subsurface location at substantially the same time. As discussed herein, such a seismic surveying technique may, in at least some embodiments, allow for improved illumination of the subsurface location while reducing the environmental impact of seismic data acquisition.

In various embodiments, the array 600 shown in FIG. 6 may be used to manufacture a geophysical data product. For example, in some embodiments, a plurality of signal sources may be deployed, in a body of water, and distributed in a source array. In some such embodiments, the plurality of signal sources may include a first signal source (e.g., source 37A in FIG. 6) positioned at a first depth in the body of water and a second signal source (e.g., source 37C in FIG. 6) positioned at a second, shallower depth in the body of water. Further, in some embodiments, the first and second depths may be controlled (e.g., in either a vertical or lateral direction through the use of one or more steering devices) such that the first signal source and the second signal source are positioned at substantially the same distance from a target subsurface location (e.g., location 202) in a geological formation. The first and second signal sources may be activated to generate first and second seismic signals. In various embodiments, seismic data, collected by one or more seismic sensors based on the activation of the first and second seismic sources, may be recorded on a tangible, computer-readable medium, thereby completing manufacture of the geophysical data product.

### Example Methods

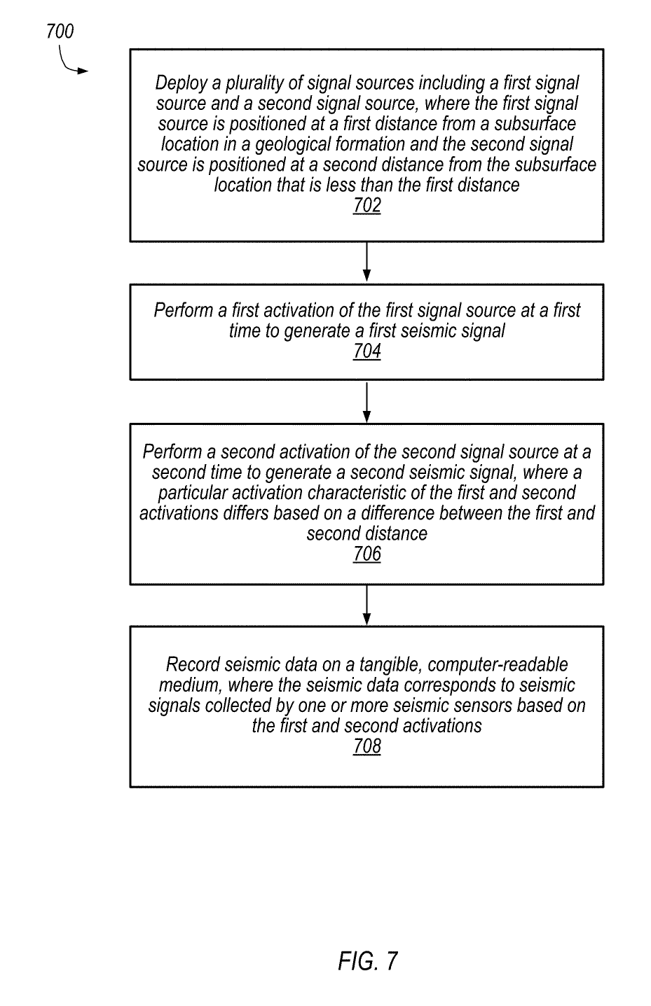

Turning now to FIG. 7, a flow diagram illustrating an example method 700 of manufacturing a geophysical data product by performing a seismic survey using a tuned signal source array is depicted, according to some embodiments. In various embodiments, method 700 may be used by seismic survey system 100 of FIG. 1 to acquire improved seismic data in an area with challenging geological structures while reducing the environmental impact on surrounding marine life. For example, in some embodiments, control equipment 12 of survey vessel 10 is configured to perform, or to cause to be performed (e.g., by controlling the activation of various signal sources 37), the operations described with reference to FIG. 7. Further, in some embodiments, control equipment 12 may include (or have access to) a non-transitory, computer-readable medium having instructions stored thereon that are executable by the control equipment 12 to cause the control equipment 12 to perform, or to cause to be performed, the operations described with reference to FIG. 7.

In FIG. 7, method 700 includes elements 702-708. While these elements are shown in a particular order for ease of understanding, other orders may be used. In various embodiments, some of the method elements may be performed concurrently, in a different order than shown, or may be omitted. Additional method elements may also be performed as desired.

Element 702 includes deploying (such as by towing or otherwise positioning) a plurality of signal sources including a first signal source and a second signal source. In the depicted embodiment, the first signal source is positioned a first distance from a subsurface location in a geological formation and the second signal source is positioned at a second distance from the subsurface location that is less than the first distance. For example, with reference to FIG. 2, the first signal source may correspond to signal source 37A and the second signal source may correspond to signal source 37C, in the depicted embodiment. Further, in some embodiments the first signal source is a first vibratory signal source and the second signal source is a second vibratory signal source. Note that, in some embodiments, the plurality of signal sources may include one or more monopole-type vibratory sources and one or more dipole-type vibratory sources. For example, in some embodiments, the plurality of signal sources may include a monopole-type vibratory source and a dipole-type vibratory source that are collocated within a signal source array. Further, in various embodiments, both the first and second signal sources may be either a monopole-type vibratory source or a dipole-type vibratory source. For example, in some embodiments, the first signal source is a monopole-type vibratory source and the second signal source is a dipole-type vibratory source. In other embodiments, however, the first signal source is a dipole-type vibratory source and the second signal source is a monopole-type vibratory source.

Method 700 then proceeds to element 704, which includes performing a first activation of the first signal source at a first time to generate a first seismic signal. For example, with reference to FIG. 2, control equipment 12 may activate signal source 37A to generate a first seismic signal at a first time. Method 700 then proceeds to element 706, which includes performing a second activation of the second signal source at a second time to generate a second seismic signal, where a particular activation characteristic of the first and second activations differs based on a difference between the first distance and the second distance. In some embodiments, the particular activation characteristic corresponds to a phase difference between the first and second seismic signals, where the second seismic signal is a time-delayed version of the first seismic signal. In some such embodiments, method 700 includes performing the first and second activations at substantially the same time. In other embodiments, the particular activation characteristic corresponds to a timing of the performing the first and second activations, where there is a delay period between the first time and the second time, and where the delay period between the first and second activations correspond to the distance between the first and second distance. That is, in some embodiments, the delay period between the first and second times is determined based on a difference between the first distance and the second distance. For example, control equipment 12 may activate signal source 37C to generate a second seismic signal at a second time, where the delay period between the first and second times corresponds to the difference in distance D₁ from source 37A to the subsurface location 202 relative to the distance from source 37C to subsurface location 202. Further, in various embodiments, the delay period is selected to cause wavefronts of the first and second seismic signals to converge at the subsurface focal point at substantially the same time. Note that, in some embodiments, method 700 may include determining the delay period(s) to apply between activations of the various sources 37 while conducting a seismic survey. In other embodiments, however, determining such delay periods may be done during a survey-planning stage, rather than during the seismic survey itself.

Additionally, note that, in some embodiments, the first seismic signal and the second seismic signal are different. For example, as described above with reference to FIG. 3B, the first and second signal sources may be activated to generate seismic signals with different amplitude levels. With reference to method 700, the control equipment 12 may activate the first and second signal sources such that the first seismic signal has an amplitude that is less than the amplitude of the second seismic signal. As discussed above, by spatially tapering the amplitude of the signals generated by the tuned array 200, various disclosed embodiments further reduce the environmental impact of seismic surveying. Further note that, in some embodiments, the first seismic signal includes a first up-going wave component and the second seismic signal includes a second up-going wave component, where the first and second up-going wave components destructively interfere such that a source ghost received at one or more of the plurality of seismic sensors is reduced.

As noted above, various disclosed embodiments are capable of using a tuned source array to generate a seismic signal within a lower frequency band than that of the signals generated by the individual sources. By generating seismic signals, using sources 37, with different frequencies, and by appropriately delaying the activation of the sources 37 such that their respective seismic signals converge at a focal point at substantially the same time, the amplitude of the combined seismic signal may be modulated by the difference frequency. For example, with reference to method 700, control equipment 12 may drive the first signal source to generate a first seismic signal at a first frequency and drive the second signal source to generate a second seismic signal at a second, different frequency. In such an embodiment, the seismic signals collected by the one or more seismic sensors may include a low frequency component that is based on a difference between the first frequency and the second, different frequency.

Further, note that, in various embodiments, control equipment 12 may drive various signal sources 37 within the array 200 based on various desired functions or digital codes. For example, as demonstrated with reference to FIGS. 5A-5B, signal sources 37 may be driven based on a sinusoidal function to generate seismic signals in which the amplitude of the pressure varies in a sinusoidal manner. In other embodiments, however, control equipment 12 may activate one or more signal sources 37 by driving those sources based on a digital code (e.g., a Gold code, m-sequence, etc.) or a function (e.g., a linearly- or non-linearly changing function). For example, with reference to method 700, in at least one embodiment, generating the first seismic signal includes activating the first signal source (e.g., a vibratory signal source) based on a first Gold code, and generating the second seismic signal includes activating the second signal source (e.g., a vibratory signal source) based on a second Gold code.

Method 700 then proceeds to element 708, which includes recording seismic data on a tangible, computer-readable medium, where the seismic data (or processed versions thereof) corresponds to seismic signals collected by one or more seismic sensors based on the first and second activations, thereby completing the manufacture of a geophysical data product.

Further, as discussed above with reference to FIG. 2, method 700 may further include adjusting one or more delay periods between activations of the signal sources 37 within a tuned array 200. For example, in some embodiments, method 700 further includes determining, based on seismic signals collected by one or more of the plurality of seismic sensors, response times associated with the first and second seismic signals and determining an updated delay period based on the response times. Additionally, in some embodiments, method 700 further includes activating the first signal source at a third time to generate a third seismic signal and, after the updated delay period, activating the second signal source at a fourth time to generate a fourth seismic signal.

Note that, in various embodiments, method 700 may include towing (e.g., by survey vessel 10 or another support vessel (not shown)) a plurality of streamers that each include a plurality of seismic sensors. For example, in FIG. 1, survey vessel 10 tows a plurality of streamers 20, each of which includes a plurality of seismic sensors 22. Note, however, that this embodiment is provided merely as an example and is not intended to limit the scope of the present disclosure. In other embodiments, for example, method 700 may include the use of any suitable arrangement or deployment of seismic sensors, such as ocean bottom cables or ocean bottom nodes.

### Example Seismic Images

Referring now to FIGS. 8A-8B, example seismic images 800 and 850 are respectively shown, according to one embodiment. More particularly, in the depicted embodiment, seismic images 800 and 850 both correspond to the same location within the subsurface of a geological formation. In the depicted embodiment, seismic image 800 was created based on seismic signals generated by a conventional, un-tuned signal source, while seismic image 850 was generated based on seismic signals generated by a tuned signal source array, as described herein. FIGS. 8A-8B demonstrate that, although corresponding to the same subsurface location, seismic images generated from conventional signal sources and tuned source arrays may differ in move-out, amplitude, and signature. Note that, in various embodiments, any of various suitable principles and methods for imaging the subsurface structures may be applied (e.g., by taking the focusing of the source wavefield from the tuned source array into account).

### Example Computing Device

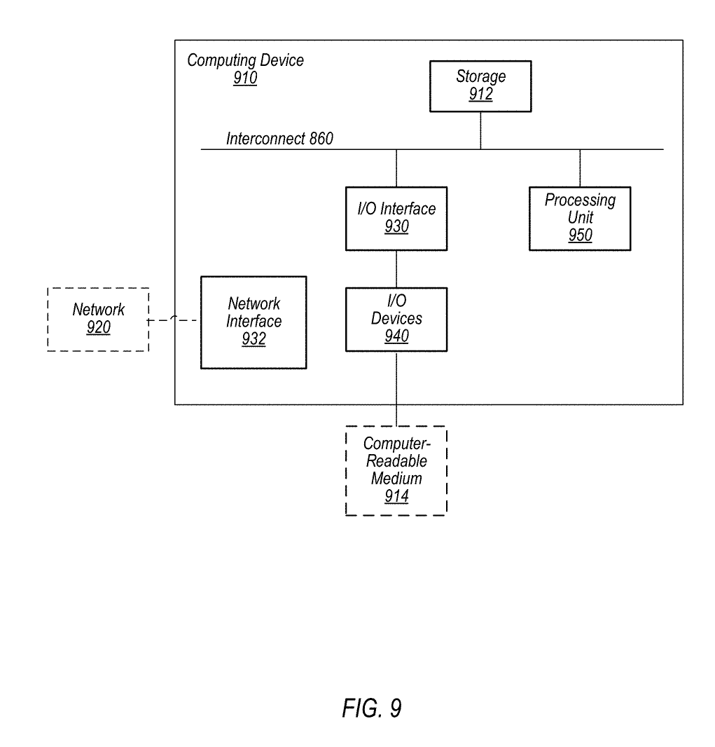

Turning now to FIG. 9, a block diagram of one embodiment of computing device (which may also be referred to as a computing system) 910 is depicted. Computing device 910 may be used to implement various portions of this disclosure. Computing device 910 may be any suitable type of device, including, but not limited to, a personal computer system, desktop computer, laptop or notebook computer, mainframe computer system, web server, workstation, or network computer. As shown, computing device 910 includes processing unit 950, storage 912, input/output (I/O) interface 930 coupled via an interconnect 960 (e.g., a system bus). I/O interface 930 may be coupled to one or more I/O devices 940. Computing device 910 further includes network interface 932, which may be coupled to network 920 for communications with, for example, other computing devices. In the illustrated embodiment, computing device 910 further includes computer-readable medium 914 as a possibly distinct element from storage subsystem 912. For example, computer-readable medium 914 may include non-transitory, persistent, tangible storage such as tape reels, hard drives, CDs, DVDs, flash memory, optical media, holographic media, or other suitable types of storage. In some embodiments, computer-readable medium 914 may be physically separable from computing device 910 to facilitate transport. In some embodiments, computer-readable medium 914 may be used to manufacture a geophysical data product. For example, in some embodiments, seismic data (generated and recorded according to any one of various disclosed embodiments), or further processed versions of such seismic data, may be stored on computer-readable medium 914, thereby completing manufacture of a geophysical data product. Although shown to be distinct from storage subsystem 912, in some embodiments, computer-readable medium 914 may be integrated within storage subsystem 912.

In various embodiments, processing unit 950 includes one or more processors. In some embodiments, processing unit 950 includes one or more coprocessor units. In some embodiments, multiple instances of processing unit 950 may be coupled to interconnect 960. Processing unit 950 (or each processor within 950) may contain a cache or other form of on-board memory. In some embodiments, processing unit 950 may be implemented as a general-purpose processing unit, and in other embodiments it may be implemented as a special purpose processing unit (e.g., an ASIC). In general, computing device 910 is not limited to any particular type of processing unit or processor subsystem.

As used herein, the terms “processing unit” or “processing element” refer to circuitry configured to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 912 is usable by processing unit 950 (e.g., to store instructions executable by and data used by processing unit 950). Storage subsystem 912 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 912 may consist solely of volatile memory in one embodiment. Storage subsystem 912 may store program instructions executable by computing device 910 using processing unit 950, including program instructions executable to cause computing device 910 to implement the various techniques disclosed herein.

I/O interface 930 may represent one or more interfaces and may be any of various types of interfaces configured to couple to and communicate with other devices, according to various embodiments. In one embodiment, I/O interface 930 is a bridge chip from a front-side to one or more back-side buses. I/O interface 930 may be coupled to one or more I/O devices 940 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. These articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

### Example Embodiments

A numbered list of example embodiments follows. Although they are written in claim-like language, these embodiments are not the claims of this application (which follow in a separate section), but are merely a number of embodiments that are specifically contemplated and disclosed herein. This list should be taken as exemplary, not exclusive.

1. A system, comprising: control equipment configured to: perform a first activation of a first signal source at a first time to generate a first seismic signal, wherein the first signal source is positioned at a first distance from a subsurface location in a geological formation; perform a second activation of a second signal source at a second time to generate a second seismic signal, wherein the second signal source is positioned at a second distance from the subsurface location that is less than the first distance, wherein a particular activation characteristic of the first and second activations differs based on a difference between the first distance and the second distance; and record sensor responses on a tangible, computer-readable medium, wherein the sensor responses correspond to seismic signals, collected by one or more seismic sensors, based on the first and second activations.

2. The system of example 1, wherein the particular activation characteristic corresponds to a phase difference between the first and second seismic signals, wherein the second seismic signal is a time-delayed version of the first seismic signal.

3. The system of any of examples 1-2, wherein the first and second activations are performed at substantially the same time.

4. The system of example 1-2, wherein the particular activation characteristic corresponds to a timing of performing the first and second activations, wherein there is a delay period between the first time and the second time, and wherein the delay period between the first and second activations corresponds to the difference between the first distance and the second distance.

5. The system of example 4, wherein the control equipment is configured to determine a duration of the delay period such that wavefronts of the first and second seismic signals converge at the subsurface location at substantially the same time.

6. The system of any of examples 1-5, wherein the first signal source is a first vibratory signal source and the second signal source is a second vibratory signal source.

7. The system of example 6, wherein, to activate the first signal source, the control equipment is configured to activate the first vibratory signal source based on a Gold code, and wherein, to activate the second signal source, the control equipment is configured to activate the second vibratory signal source based on the Gold code.

8. The system of any of examples 1-7, wherein the control equipment is configured to activate the first and second signal sources such that an amplitude of the first seismic signal is less than an amplitude of the second seismic signal.

9. The system of any of examples 1-8, wherein the first seismic signal and the second seismic signal are different.

10. The system of any of examples 1-9, wherein performing the first activation includes driving the first signal source to generate the first seismic signal at a first frequency, wherein performing the second activation includes driving the second signal source to generate the second seismic signal at a second, different frequency, and wherein the seismic signals collected by the one or more seismic sensors includes a low frequency component based on a difference between the first frequency and the second, different frequency.

11. The system of any of examples 1-10, wherein the control equipment is further configured to: determine, based on the seismic signals collected by the one or more of the seismic sensors, response times associated with the first and second seismic signals; and determine an updated delay period based on the response times.

12. The system of any of examples 1-11, wherein the first signal source is a monopole-type vibratory signal source and the second signal source is a dipole-type vibratory signal source.

13. The system of an of examples 1-12, wherein the first seismic signal includes a first up-going wave component and the second seismic signal includes a second up-going wave component, wherein the first and second up-going wave components destructively interfere such that a source ghost received at one or more of the seismic sensors is reduced.

14. The system of any of examples 1-13, wherein the control equipment is configured to control a plurality of signal sources, wherein the plurality of signal sources includes a monopole-type vibratory signal source and a dipole-type vibratory signal source.

15. The system of example 14, wherein the monopole-type vibratory signal source and the dipole-type vibratory signal source are collocated within a signal source array.

16. The system of any of examples 1-15, wherein the control equipment is further configured to: perform a third activation of the first signal source at a third time to generate a third seismic signal; and perform a fourth activation of the second signal source at a fourth time to generate a fourth seismic signal, wherein there is an adjusted delay period between the third time and the fourth time, and wherein the adjusted delay period is selected such that wavefronts of the third and fourth seismic signals converge at a different subsurface location at substantially the same time.

17. A method of manufacturing a geophysical data product, comprising: deploying a plurality of signal sources including a first signal source and a second signal source; wherein the first signal source is positioned at a first distance from a subsurface location in a geological formation and the second signal source is positioned at a second distance from the subsurface location that is less than the first distance; performing a first activation of the first signal source at a first time to generate a first seismic signal; performing a second activation of the second signal source at a second time to generate a second seismic signal, wherein a particular activation characteristic of the first and second activations differs based on a difference between the first distance and the second distance; and recording seismic data on a tangible, computer-readable medium, wherein the seismic data corresponds to seismic signals collected by one or more seismic sensors based on the first and second activations.

18. The method of example 17, wherein the particular activation characteristic corresponds to a phase difference between the first and second seismic signals, wherein the second seismic signal is a time-delayed version of the first seismic signal.

19. The method of any of examples 17-18, wherein the first and second activations are performed at substantially the same time.

20. The method of example 17-18, wherein the particular activation characteristic corresponds to a timing of the performing the first and second activations, wherein there is a delay period between the first time and the second time, and wherein the delay period between the first and second activations corresponds to the difference between the first distance and the second distance.

21. The method of example 20, wherein the delay period is selected to cause wavefronts of the first and second seismic signals to converge at the subsurface location at substantially the same time.

22. The method of any of examples 17-21, wherein an amplitude of the first seismic signal is less than an amplitude of the second seismic signal.

23. The method of any of examples 17-22, wherein the first signal source is a first vibratory signal source and the second signal source is a second vibratory signal source.

24. The method of any of examples 17-23, wherein the performing the first activation includes driving the first signal source to generate the first seismic signal at a first frequency, wherein the performing the second activation includes driving the second signal source to generate the second seismic signal at a second, different frequency, and wherein the seismic signals collected by the one or more seismic sensors includes a low frequency component based on a difference between the first frequency and the second, different frequency.

25. The method of any of examples 17-24, further comprising: determining, based on the seismic signals collected by the one or more of the seismic sensors, response times associated with the first and second seismic signals; and determining an updated delay period based on the response times.

26. The method of example 25, further comprising: performing a third activation of the first signal source at a third time to generate a third seismic signal; and after the updated delay period, performing a fourth activation of the second signal source at a fourth time to generate a fourth seismic signal.

27. The method of any of examples 17-26, wherein generating the first seismic signal includes activating the first vibratory signal source based on a Gold code, and wherein generating the second seismic signal includes activating the second vibratory signal source based on the Gold code.

28. The method of any of examples 17-27, wherein the plurality of signal sources includes a monopole-type vibratory signal source and a dipole-type vibratory signal source.

29. The method of example 28, wherein the monopole-type vibratory signal source and the dipole-type vibratory signal source are collocated within a signal source array.

30. The method of any of examples 17-29, wherein the first signal source is a monopole-type vibratory signal source and the second signal source is a dipole-type vibratory signal source.

31. The method of any of examples 17-30, wherein the first seismic signal includes a first up-going wave component and the second seismic signal includes a second up-going wave component, wherein the first and second up-going wave components destructively interfere such that a source ghost received at one or more of the seismic sensors is reduced.

32. The method of any of examples 17-31, further comprising: performing a third activation of the first signal source at a third time to generate a third seismic signal; and performing a fourth activation of the second signal source at a fourth time to generate a fourth seismic signal, wherein there is an adjusted delay period between the third time and the fourth time, and wherein the adjusted delay period is selected such that wavefronts of the third and fourth seismic signals converge at a different subsurface location at substantially the same time.

33. A non-transitory, computer-readable medium having instructions stored thereon that are executable by control equipment to perform operations comprising: performing a first activation of a first signal source at a first time to generate a first seismic signal, wherein the first signal source is positioned at a first distance from a subsurface location in a geological formation; performing a second activation of a second signal source at a second time to generate a second seismic signal, wherein the second signal source is positioned at a second distance from the subsurface location that is less than the first distance, wherein a particular activation characteristic of the first and second activations is based on a difference between the first distance and the second distance; and recording seismic data on a tangible, computer-readable medium, wherein the seismic data corresponds to seismic signals, collected by one or more seismic sensors, based on the first and second activations.

34. The non-transitory, computer-readable medium of example 33, wherein the particular activation characteristic corresponds to a phase difference between the first and second seismic signals, wherein the second seismic signal is a time-delayed version of the first seismic signal.

35. The non-transitory, computer-readable medium of any of examples 33-34, wherein the first and second activations are performed at substantially the same time.

36. The non-transitory, computer-readable medium of example 33-34, wherein the particular activation characteristic corresponds to a timing of the performing the first and second activations, wherein there is a delay period between the first time and the second time, and wherein the delay period between the first and second activations corresponds to the difference between the first distance and the second distance.

37. The non-transitory, computer-readable medium of example 36, wherein the delay period is selected to cause wavefronts of the first and second seismic signals to converge at the subsurface location at substantially the same time.

38. The non-transitory, computer-readable medium of any of examples 33-37, wherein the first signal source is a first vibratory signal source and the second signal source is a second vibratory signal source.

39. The non-transitory, computer-readable medium of any of examples 33-38, wherein the performing the second activation at the second time includes generating the second seismic signal to have an amplitude that is greater than the amplitude of the first seismic signal.

40. The non-transitory, computer-readable medium of any of examples 33-39, wherein the operations further comprise: determining, based on the seismic signals collected by the one or more seismic sensors, response times associated with the first and second seismic signals; and determining an updated delay period based on the response times.

41. The non-transitory, computer-readable medium of example 40, wherein the operations further comprise: performing a third activation of the first signal source at a third time to generate a third seismic signal; and after the updated delay period, performing a fourth activation of the second signal source at a fourth time to generate a fourth seismic signal.

42. The non-transitory, computer-readable medium of any of examples 33-41, wherein the performing the first activation includes driving the first signal source to generate the first seismic signal at a first frequency, wherein the performing the second activation includes driving the second signal source to generate the second seismic signal at a second, different frequency, and wherein the seismic signals collected by the one or more seismic sensors includes a low frequency component based on a difference between the first frequency and the second, different frequency.

43. The non-transitory, computer-readable medium of any of examples 33-42, wherein the first and second signal sources are included in a plurality of signal sources, wherein the plurality of signal sources includes a monopole-type vibratory signal source and a dipole-type vibratory signal source.

44. The non-transitory, computer-readable medium of example 43, wherein the monopole-type vibratory signal source and the dipole-type vibratory signal source are collocated within a signal source array.

45. The non-transitory, computer-readable medium of any of examples 33-44, wherein the first signal source is a monopole-type vibratory signal source and the second signal source is a dipole-type vibratory signal source.

46. The non-transitory, computer-readable medium of any of examples 33-45, wherein the first seismic signal includes a first up-going wave component and the second seismic signal includes a second up-going wave component, wherein the first and second up-going wave components destructively interfere such that a source ghost received at one or more of the seismic sensors is reduced.

47. A method of manufacturing a geophysical data product, comprising: deploying, in a body of water, a plurality of signal sources distributed in a source array, wherein the plurality of signal sources includes: a first signal source positioned at a first depth in the body of water; and a second signal source positioned at a second, shallower depth in the body of water; controlling the first and second depths such that the first signal source and the second signal source are positioned at substantially the same distance from a target subsurface location in a geological formation; activating the first and second signal sources to generate first and second seismic signals; and recording seismic data on a tangible, computer-readable medium, wherein the seismic data corresponds to seismic signals collected by one or more seismic sensors based on the activating the first and second signal sources.

48. The method of example 47, wherein the first and second signal sources are activated at substantially the same time.

49. The method of any of examples 47-48, wherein an amplitude of the first seismic signal is less than an amplitude of the second seismic signal.

50. The method of any of examples 47-49, wherein the activating the first and second signal sources comprises: driving the first signal source to generate the first seismic signal at a first frequency; and driving the second signal source to generate the second seismic signal at a second, different frequency, and wherein the seismic signals collected by the one or more seismic sensors include a low frequency component based on a difference between the first frequency and the second, different frequency.

51. The method of any of examples 47-50, wherein the plurality of signal sources includes a monopole-type vibratory signal source and a dipole-type vibratory signal source.

52. The method of example 51, wherein the monopole-type vibratory signal source and the dipole-type vibratory signal source are collocated within a signal source array.

53. The method of any of examples 47-52, wherein the first seismic signal includes a first up-going wave component and the second seismic signal includes a second up-going wave component, wherein the first and second up-going wave components destructively interfere such that a source ghost received at one or more of the seismic sensors is reduced.

54. A system, comprising: control equipment configured to: control respective depths, within a body of water, of a plurality of signal sources distributed in a source array, wherein the plurality of signal sources includes: a first signal source positioned at a first depth in the body of water; and a second signal source positioned at a second, shallower depth in the body of water, wherein control equipment is configured to control the first and second depths to position the first signal source and second signal source at substantially the same distance from a target subsurface location in a geological formation; activate the first and second signal sources to generate first and second seismic signals; and record sensor responses on a tangible, computer-readable medium, wherein the sensor responses correspond seismic signals collected by one or more seismic sensors based on the activation of the first and second signal sources.

55. The system of example 54, wherein the control equipment is configured to activate the first and second signal sources at substantially the same time.

56. The system of any of examples 54-55, wherein an amplitude of the first seismic signal is less than an amplitude of the second seismic signal.

57. The system of any of examples 54-56, wherein, to activate the first and second signal sources, the control equipment is configured to: drive the first signal source to generate the first seismic signal at a first frequency; and drive the second signal source to generate the second seismic signal at a second, different frequency, and wherein the seismic signals collected by the one or more seismic sensors include a low frequency component based on a difference between the first frequency and the second, different frequency.

58. The system of any of examples 54-57, wherein the plurality of signal sources includes a monopole-type vibratory signal source and a dipole-type vibratory signal source.

59. The system of example 58, wherein the monopole-type vibratory signal source and the dipole-type vibratory signal source are collocated within a signal source array.

60. The system of any of examples 54-59, wherein the first seismic signal includes a first up-going wave component and the second seismic signal includes a second up-going wave component, wherein the first and second up-going wave components destructively interfere such that a source ghost received at one or more of the seismic sensors is reduced.

61. A non-transitory, computer-readable medium having instructions stored thereon that are executable by control equipment to perform operations comprising: deploying, in a body of water, a plurality of signal sources distributed in a source array, wherein the plurality of signal sources includes: a first signal source positioned at a first depth in the body of water; and a second signal source positioned at a second, shallower depth in the body of water; controlling the first and second depths such that the first signal source and the second signal source are positioned at substantially the same distance from a target subsurface location in a geological formation; activating the first and second signal sources to generate first and second seismic signals; and recording seismic data on a tangible, computer-readable medium, wherein the seismic data corresponds to seismic signals collected by one or more seismic sensors based on the activating the first and second signal sources.

62. The non-transitory, computer-readable medium of example 61, wherein the first and second signal sources are activated at substantially the same time.

63. The non-transitory, computer-readable medium of any of examples 61-62, wherein an amplitude of the first seismic signal is less than an amplitude of the second seismic signal.

64. The non-transitory, computer-readable medium of any of examples 61-63, wherein the activating the first and second signal sources comprises: driving the first signal source to generate the first seismic signal at a first frequency; and driving the second signal source to generate the second seismic signal at a second, different frequency, and wherein the seismic signals collected by the one or more seismic sensors include a low frequency component based on a difference between the first frequency and the second, different frequency.

65. The non-transitory, computer-readable medium of any of examples 61-64, wherein the plurality of signal sources includes a monopole-type vibratory signal source and a dipole-type vibratory signal source, wherein the monopole-type vibratory signal source and the dipole-type vibratory signal source are collocated within a signal source array.

66. The non-transitory, computer-readable medium of any of examples 61-65, wherein the first seismic signal includes a first up-going wave component and the second seismic signal includes a second up-going wave component, wherein the first and second up-going wave components destructively interfere such that a source ghost received at one or more of the seismic sensors is reduced.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method of manufacturing a geophysical data product, comprising:
deploying, in a body of water, a plurality of signal sources distributed in a source array, wherein the plurality of signal sources includes:
a first signal source positioned at a first depth in the body of water; and
a second signal source positioned at a second, shallower depth in the body of water;
controlling the first and second depths such that the first signal source and the second signal source are positioned at substantially the same distance from a target subsurface location in a geological formation;
activating the first and second signal sources to generate first and second seismic signals; and
recording seismic data on a tangible, computer-readable medium, wherein the seismic data corresponds to seismic signals collected by one or more seismic sensors based on the activating the first and second signal sources.

2. The method of claim 1, wherein the first and second signal sources are activated at substantially the same time.

3. The method of claim 1, wherein an amplitude of the first seismic signal is less than an amplitude of the second seismic signal.

4. The method of claim 1, wherein the activating the first and second signal sources comprises:
driving the first signal source to generate the first seismic signal at a first frequency; and
driving the second signal source to generate the second seismic signal at a second, different frequency, and wherein the seismic signals collected by the one or more seismic sensors include a low frequency component based on a difference between the first frequency and the second, different frequency.

5. The method of claim 1, wherein the plurality of signal sources includes a monopole-type vibratory signal source and a dipole-type vibratory signal source.

6. The method of claim 5, wherein the monopole-type vibratory signal source and the dipole-type vibratory signal source are collocated within a signal source array.

7. The method of claim 5, wherein the first seismic signal includes a first up-going wave component and the second seismic signal includes a second up-going wave component, wherein the first and second up-going wave components destructively interfere such that a source ghost received at one or more of the seismic sensors is reduced.

8. A system, comprising:
control equipment configured to:
control respective depths, within a body of water, of a plurality of signal sources distributed in a source array, wherein the plurality of signal sources includes:
a first signal source positioned at a first depth in the body of water; and
a second signal source positioned at a second, shallower depth in the body of water, wherein control equipment is configured to control the first and second depths to position the first signal source and second signal source at substantially the same distance from a target subsurface location in a geological formation;
activate the first and second signal sources to generate first and second seismic signals; and
record sensor responses on a tangible, computer-readable medium, wherein the sensor responses correspond seismic signals collected by one or more seismic sensors based on the activation of the first and second signal sources.

9. The system of claim 8, wherein the control equipment is configured to activate the first and second signal sources at substantially the same time.

10. The system of claim 8, wherein an amplitude of the first seismic signal is less than an amplitude of the second seismic signal.

11. The system of claim 8, wherein, to activate the first and second signal sources, the control equipment is configured to:
drive the first signal source to generate the first seismic signal at a first frequency; and
drive the second signal source to generate the second seismic signal at a second, different frequency, and wherein the seismic signals collected by the one or more seismic sensors include a low frequency component based on a difference between the first frequency and the second, different frequency.

12. The system of claim 8, wherein the plurality of signal sources includes a monopole-type vibratory signal source and a dipole-type vibratory signal source.

13. The system of claim 12, wherein the monopole-type vibratory signal source and the dipole-type vibratory signal source are collocated within a signal source array.

14. The system of claim 8, wherein the first seismic signal includes a first up-going wave component and the second seismic signal includes a second up-going wave component, wherein the first and second up-going wave components destructively interfere such that a source ghost received at one or more of the seismic sensors is reduced.

15. A non-transitory, computer-readable medium having instructions stored thereon that are executable by control equipment to perform operations comprising:
deploying, in a body of water, a plurality of signal sources distributed in a source array, wherein the plurality of signal sources includes:
a first signal source positioned at a first depth in the body of water; and
a second signal source positioned at a second, shallower depth in the body of water;
controlling the first and second depths such that the first signal source and the second signal source are positioned at substantially the same distance from a target subsurface location in a geological formation;
activating the first and second signal sources to generate first and second seismic signals; and
recording seismic data on a tangible, computer-readable medium, wherein the seismic data corresponds to seismic signals collected by one or more seismic sensors based on the activating the first and second signal sources.

16. The non-transitory, computer-readable medium of claim 15, wherein the first and second signal sources are activated at substantially the same time.

17. The non-transitory, computer-readable medium of claim 15, wherein an amplitude of the first seismic signal is less than an amplitude of the second seismic signal.

18. The non-transitory, computer-readable medium of claim 15, wherein the activating the first and second signal sources comprises:
driving the first signal source to generate the first seismic signal at a first frequency; and
driving the second signal source to generate the second seismic signal at a second, different frequency, and wherein the seismic signals collected by the one or more seismic sensors include a low frequency component based on a difference between the first frequency and the second, different frequency.

19. The non-transitory, computer-readable medium of claim 15, wherein the plurality of signal sources includes a monopole-type vibratory signal source and a dipole-type vibratory signal source, wherein the monopole-type vibratory signal source and the dipole-type vibratory signal source are collocated within a signal source array.

20. The non-transitory, computer-readable medium of claim 15, wherein the first seismic signal includes a first up-going wave component and the second seismic signal includes a second up-going wave component, wherein the first and second up-going wave components destructively interfere such that a source ghost received at one or more of the seismic sensors is reduced.
